(19) United States
(12) Patent Application Publication
(10) Pub. No.: US 2026/0234977 A1
(43) Pub. Date: Aug. 13, 2026

(54) DOOR CLOSER

(71) Applicant: dormakaba Deutschland GmbH, Ennepetal (DE)

(72) Inventors: Volker BIENEK, Ennepetal (DE); Thomas PABST, Ennepetal (DE); Marcus BRUNS, Ennepetal (DE)

(21) Appl. No.: 19/446,501

(22) Filed: Jan. 12, 2026

(30) Foreign Application Priority Data
Jan. 13, 2025 (EP) 25151601.9

(51) Int. Cl. E05F 3/12; E05F 1/10; E05F 3/10; E05F 3/18; E05F 3/22

(52) U.S. Cl. CPC E05F 3/12; E05F 1/105; E05F 3/10; E05F 3/18; E05F 3/227; E05Y 2201/11; E05Y 2201/212; E05Y 2201/224; E05Y 2201/264; E05Y 2600/63; E05Y 2800/12; E05Y 2800/24; E05Y 2800/40; E05Y 2900/132

(57) ABSTRACT

A door closer for opening and/or closing a door, the door closer having a hydraulic damping mechanism for damping the opening and/or closing of the door with at least one valve for setting the damping properties of the damping mechanism, the valve having a valve guide that has a first threaded section and a valve element arranged within the valve guide and that has a second threaded section, which can be brought into engagement with each other to form an adjusting threaded connection for adjusting the valve element within the valve guide in the axial direction, with the door closer having a stop safety device for securing the valve element within the valve guide in the axial direction. The valve guide has a freewheel section and the valve element is adjustable within the valve guide in the axial direction such that the first and second threaded sections are disengaged.

### CROSS-REFERENCE TO RELATED APPLICATIONS

This application claims the benefit of European patent application no. 25151601.9, filed on 13 Jan. 2025, the disclosure of which is incorporated herein by reference in its entirety.

### TECHNICAL FIELD

The application relates to a door closer for opening and/or closing a door according to the preamble of the claims. Furthermore, the application relates to a door system according to the preamble of the claims with a proposed door closer.

### BACKGROUND

Door closers of this kind can be used for various applications on doors. It is therefore conceivable that a door closer in question prevents or at least reduces the impact of a comparatively heavy door leaf of a door on parts of the building, such as for example walls, in the event of a rapid opening movement of the door leaf. Alternatively or additionally, it is conceivable that in the event of a closing movement, the closing speed of the door leaf is reduced by the door closer, which prevents or at least reduces, for example, the door leaf from impacting a door frame.

The door closer in question has a hydraulic damping mechanism for damping the opening and/or closing of the door. For example, a hydraulic fluid, such as oil or an oil mixture, can flow through the damping mechanism with flow resistance within the door closer when the door is opened and/or closed and cause damping. The damping mechanism has at least one valve that can be used to set the damping properties of the damping mechanism. The valve can be used to set the flow of the hydraulic fluid and thus ultimately the damping properties of the damping mechanism.

The valve has a valve guide and a valve element arranged within the valve guide. Both the valve guide and the valve element each have a threaded section via which the valve guide and the valve element are connected to each other. The threaded sections engage with each other in such manner that they form an adjusting threaded connection for adjusting the valve element within the valve guide in the axial direction. By adjusting the valve element within the valve guide, the flow of the hydraulic fluid can be set when opening and/or closing. For example, it may be that unscrewing the valve element reduces the damping effect and screwing the valve element in increases the damping effect.

The damping property of the damping mechanism is set via the valve, for example by a fitter as part of the installation of the door closer. When installing the door closer, it may be provided to first mount and set the mechanical components and functions of the door closer (such as attaching the door closer, setting springs, etc.) before fine-tuning and, in particular, setting the damping properties of the damping mechanism.

For the mounting and setting of mechanical components, it is often necessary to first remove or at least reduce the damping effect. To do this, the valve can be opened by unscrewing the valve element, usually directly accessible from the outside, for example partially from the valve guide. After successful mounting and setting, the damping effect is then set as part of the fine adjustment. To do this, the valve can be closed at least partially by screwing the valve element into the valve guide, for example.

There is always a risk of damaging the hydraulic damping mechanism during installation. For example, air can enter via the valve or even hydraulic fluid can escape if the valve is opened too far. It is even possible that the valve element is unscrewed so far from the valve guide that it is lost. In both cases, the door closer can only be installed ready for use, if at all, with considerable additional effort.

In principle, door closers are known which have a stop safety device to meet the above challenge. The valve element can be secured within the valve guide in the axial direction by way of the stop safety device, for example by fixing the movability of the valve element. This prevents, for example, the valve element from being unscrewed beyond a certain point when the valve is opened.

Although this prevents the loss of the valve element in these door closers and prevents the valve from opening “too far”, these door closers also pose a certain challenge in connection with the installation of the door closer. This is because while the fitter often has to apply comparatively high forces when mounting and setting the mechanical components of the door closer, the fitter generally has to apply comparatively lower forces and work very carefully during the fine adjustment. If the fitter is not careful, the valve, for example the valve element, the valve guide and in particular the adjusting threaded connection, and/or the housing and/or the stop safety device can be damaged quickly.

### SUMMARY

Against this background, the present disclosure provides a door closer that is comparatively easy to install.

This advantage is achieved in a door closer of the type mentioned at the outset in that the valve guide has a freewheel section and in that the valve element can be adjusted within the valve guide in the axial direction in such manner that the first threaded section and the second threaded section are disengaged. The freewheel section allows the threaded sections that are engaged with each other to be separated from each other as required, i.e. can be brought out of engagement. This is achieved by adjusting the valve element within the valve guide in such manner that the second threaded section is moved completely into the freewheel section.

If the threaded sections are engaged with each other, the valve element can be moved within the valve guide by screwing. For example, when a torque is exerted on the valve element by the fitter via a tool, the screw threaded connection results in a screwing movement of the valve element in the axial direction. In this respect, the adjusting threaded connection can cause a stroke of the screwed valve element in the axial direction when the threaded sections are engaged. This allows the valve to be adjusted and the damping properties of the damping mechanism to be set as required.

If the threaded sections are brought out of engagement, the valve element can no longer be screwed within the valve guide. If the threaded sections are disengaged, a stroke of the valve element cannot be caused in the axial direction, at least not by the adjusting threaded connection. This does not rule out the possibility that the valve element can move within the valve guide, for example due to a tensile and/or compressive force.

This prevents the valve element from being moved, in particular screwed, beyond a certain point with respect to the valve guide as part of the installation. This can be the case in particular if the door closer is designed without a stop safety device. Damage to the damping mechanism caused by air entering and/or hydraulic fluid escaping can be avoided. It is also possible to prevent the valve from being adjusted with excessive force as part of the installation. This can be the case in particular if the door closer has a stop safety device. Damage to certain components of the door closer, such as the valve element, the valve guide and in particular the adjusting threaded connection and/or, if provided, a housing and/or, if provided, the stop safety device, can also be avoided. Overall, the installation of the door closer is simplified due to the proposed configuration.

As already mentioned above, a particularly advantageous configuration of the door closer can provide that the door closer has a stop safety device for securing the valve element within the valve guide in the axial direction.

Advantageously, it can be provided that the valve element, when this is adjusted in such manner that the first threaded section and the second threaded section are disengaged, can be adjusted, in particular moved, in the axial direction into at least one end position, with the stop safety device fixing the end position of the valve element and securing the valve element in the end position. In this way, the stop safety device reliably prevents the valve element from being moved beyond a certain point when the threaded sections are disengaged and the second threaded section is adjusted into the freewheel section.

Advantageously, when the valve element is adjusted in such manner that the first threaded section and the second threaded section are disengaged, in particular when the valve element is adjusted into the end position, it can be moved into a further end position in which the first threaded section and the second threaded section can be brought into engagement with each other. This ensures that the first threaded section of the valve guide and the second threaded section of the valve element can be brought into engagement with each other as required and, preferably, repeatedly. The end position can correspond to a first end position and the further end position to a second end position.

To further simplify the fine adjustment and thus installation, it can also be advantageous if the freewheel section has a centring region at the end for centring the valve element within the valve guide. The centring region of the freewheel section can centre the valve element as the valve element moves, in particular proceeding from the end position to the further end position. This makes it easier to bring the threaded sections into engagement with each other. It can be provided that the centring region is conical in shape.

A further advantageous configuration of the door closer can provide that the door closer has a housing and that the valve guide is arranged on and/or in the housing. The housing can protect at least a part of the components of the door closer from external environmental influences, such as moisture and dirt. Although it is not absolutely necessary, the valve guide can be arranged in the housing in a space-saving manner.

In regard to comparatively simple and cost-effective production, it may be provided for the valve guide to be designed in the manner of a guide bore with different diameters. The valve guide, which is designed in the manner of a guide bore, can be realised as part of the production by machining the housing, such as in particular by drilling, or directly as part of the production of the housing, for example by a casting process. “In the manner of a guide bore” is to be understood broadly in this respect and refers in particular to the manner of geometric configuration of the valve guide. The freewheel section can thus represent part of the valve guide, which is designed in the manner of a guide bore. In general, it is conceivable that the freewheel section has a larger diameter, at least in sections, compared to the first threaded section.

In connection with the housing, it can be advantageously provided that the door closer has a cover which is arranged on the housing and at least partially covers the housing. The cover can thus contribute to or supplement the protective function of the housing. The cover can advantageously have a, in particular substantially flat, plate section, and/or a, in particular curved, shell section.

In connection with the cover, it has proven to be in particular advantageous if the stop safety device is arranged on the cover, in particular on the plate section. The stop safety device can preferably be arranged on the cover, in particular on the plate section, in a non-rotatable manner. The stop safety device can preferably be arranged on the cover, in particular on the plate section, in a non-detachable manner. This prevents unintentional loosening of the stop safety device, for example as the valve is adjusted, in particular with respect to the cover.

In regard to a simple and cost-effective production, it is a great advantage if the stop safety device is moulded onto the cover, in particular onto the plate section. This eliminates the need for additional components, which may have to be mounted individually. It can be particularly advantageous if the stop safety device is arranged in line with the plate section.

Advantageously, the cover can be configured in such manner that the housing can be fastened via the cover, in particular to the door and/or to a wall, floor or ceiling of a room to which the door is assigned. The cover can have a dual function in this respect in that the housing is covered by the cover, in particular in the state of the door closer mounted on the door, wall, floor or ceiling, and is also fastened via the cover. The cover and the housing can be screwed together. It can be particularly advantageously provided that the door closer can be arranged or is arranged in or on the door or in or on the wall, floor or ceiling of the room.

A further advantageous configuration provides that the stop safety device is arranged in a non-rotatable manner with respect to the valve guide. This prevents unintentional loosening of the stop safety device, for example as the valve is adjusted, in particular with respect to the valve guide.

Alternatively or additionally, it can be advantageous if the stop safety device is arranged in a non-rotatable manner with respect to the housing. This can also prevent unintentional loosening of the stop safety device, for example as the valve is adjusted, in particular with respect to the housing.

The stop safety device can advantageously be threadless. This simplifies production, as there is no need for the comparatively complex production of a thread in connection with the stop safety device. It is conceivable that the stop safety device is arranged, preferably moulded, adhered, welded, etc., to another component of the door closer, such as in particular the cover.

It is possible that the stop safety device secures the valve element along a securing surface in a form-fitting manner. Securing the valve element in a form-fitting manner by way of the stop safety device is easy to implement in terms of design and is functionally reliable. It is particularly advantageous if the securing surface is in the form of a circumferential securing surface. Due to the circumferential securing surface, the valve element can be secured evenly, for example via a corresponding counter surface, which reduces the risk of the valve element tilting within the valve guide. It is possible that the securing surface is in the form of a circumferential ring-shaped securing surface.

A further advantageous configuration provides that the valve element has a tool receptacle, in particular at the end, for temporarily receiving a tool, in particular a screwing tool. This allows the valve element to be adjusted, for example by temporarily connecting the tool to the valve element via the tool receptacle. The connected tool can be used to move the valve element into the valve guide by screwing when the first threaded section and the second threaded section are engaged with each other.

In order to simplify the installation and in particular the adjustment of the valve, it is particularly advantageous if the stop safety device is arranged in the axial direction with respect to the valve element and has a recess for the tool to pass through the stop safety device to the tool receptacle. This allows the valve, in particular the valve element, to be adjusted in a mounting-friendly manner, in particular if the door closer is already mounted on the door, the wall, the ceiling or the floor. The axial direction can in particular run along the longitudinal axis of the valve element and/or the valve guide.

A further advantageous configuration of the door closer provides that the door closer has a sealing arrangement for sealing the hydraulic damping mechanism, in particular with respect to the exterior of the housing. The sealing arrangement prevents hydraulic fluid from escaping and air, dirt and/or moisture from entering the hydraulic damping mechanism. It can be advantageously provided that the sealing arrangement has a sealing element and that the sealing element is arranged in a sealing manner between the valve guide and the valve element. It is quite particularly preferably provided that the sealing element is arranged between the valve guide and the valve element in such manner that a or the sealing effect is achieved by the sealing element both when the threaded sections are engaged and when the threaded sections are disengaged, in particular when the valve element is moved into the end position. The sealing element is assigned to the valve and has a sealing effect in the region of the valve. It is possible that the sealing element is arranged between the valve guide and the valve element in a radially sealing manner. The sealing element can preferably be in the form of an elastic sealing element, such as an O-ring.

In this context, it has proven useful if the sealing element is arranged on the valve element and can be moved with the valve element in an axial direction. This ensures that the sealing effect of the sealing element is maintained even as the valve element is adjusted within the valve guide. Alternatively, it is also conceivable that the sealing element is arranged on the valve guide and the valve element can be moved in an axial direction with respect to the sealing element and the valve guide.

The valve guide can advantageously have a fluid region and a dry region, with the sealing element spatially separating the fluid region and the dry region, in particular within the valve guide. The sealing element creates a seal between the fluid region and the dry region. The fluid region in particular has hydraulic fluid. The dry region is in particular free of hydraulic fluid. In this context, it is advantageously possible that the first threaded section and/or the second threaded section is or are arranged in the fluid region. Alternatively or additionally, it is conceivable that the dry region is threadless.

According to a further advantageous configuration, it is provided that the valve element has a closing section for closing and/or opening at least one channel of the damping mechanism. The channel can be reliably closed and/or opened via the closing section, for example when adjusting the valve. This allows the damping properties of the damping mechanism to be set. The closing section is preferably arranged opposite the tool receptacle. It is advantageously possible that the channel protrudes through the first threaded section. The closing section preferably has a closing pin.

According to a further teaching, which has independent significance, a door system with a door having a door leaf and a door closer is proposed. The door closer enables the door to be opened and/or closed. To achieve the above-mentioned advantage, the door closer is configured as proposed. The door closer can have one or a plurality of the features described in connection with the proposed door closer. Reference is made to all comments on the proposed door closer.

The door closer can be arranged on the door leaf, in particular partially in the door leaf.

Advantageously, the door closer can have the housing, which is arranged in the door leaf. It is possible that the door closer has the cover and that the housing arranged in the door leaf is fastened to the door leaf via the cover. The cover can in particular close off a receiving region of the door closer in the door in a manner flush with the door.

The door of the door system can have a door frame next to the door leaf. It is possible that the door closer is functionally arranged between the door leaf and the door frame. The door system can have a linkage, such as a lever arm linkage or scissor linkage, which couples the door leaf and the door frame together via the door closer. The linkage can be arranged on one side of the door closer. It is conceivable that the door closer is arranged on the door frame, in particular partially in the door frame. The housing of the door closer can be arranged in the door frame. It is possible that the door closer has the cover and that the housing arranged in the door frame is fastened to the door frame via the cover. The cover can in particular close off a receiving region of the door closer in the door frame in a manner flush with the door frame.

In general, the door system can have a room, with the door being able to be assigned to this room. The room can in particular have a wall, a floor and/or a ceiling. It is possible that the door closer is functionally arranged between the door leaf and the wall, the floor or the ceiling. The linkage can couple the door leaf and the wall, the floor or the ceiling to each other via the door closer. It is conceivable that the door closer is arranged on the wall, the floor or the ceiling, in particular partially in the wall, the floor or the ceiling. The housing of the door closer can be arranged in the wall, the floor or the ceiling, with the housing being fastened to the wall, the floor or the ceiling in particular via the cover. The cover can in particular close off a receiving region of the door closer in the wall, the floor or the ceiling so that it is flush.

### BRIEF DESCRIPTION OF THE DRAWINGS

The disclosure will be explained in more detail below on the basis of figures representing only exemplary embodiments. The figures show

FIG. 1 a proposed door closer in a) a plan view with a view of a cover of the door closer and in b) a closing view along the sectional line represented in FIG. 1a), with certain hatchings being omitted for the sake of clarity,

FIG. 2: a detailed representation of the sectional view from FIG. 1b), with a valve of the door closer being adjusted in a) into a closed position and in b) and c) into an open position, and

FIG. 3: a schematic overview of the door closer arranged on a door.

### DETAILED DESCRIPTION OF THE DRAWINGS

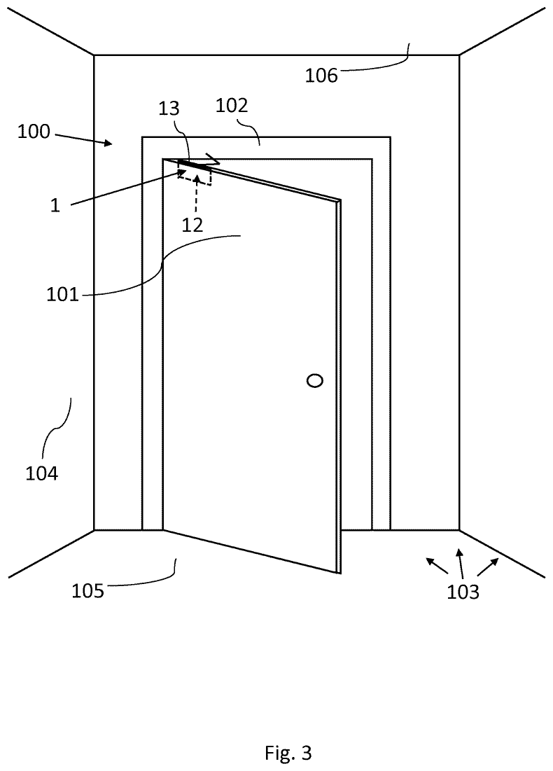

The exemplary embodiment represented in the figures and preferred in this respect relates to a door closer 1 for opening and/or closing a door 100. The door closer 1 can be arranged on a door 100, which has a door leaf 101 and, preferably, a door frame 102. When opening and/or closing the door 100, i.e. during an opening and/or closing movement of the door leaf 101, the door closer 1 can support, dampen and/or execute the corresponding process depending on the intended functionalities. This is represented schematically in FIG. 3, in which the door closer 1 and the door 100 with the door leaf 101 are assigned to a proposed door system. The door system can comprise a room 103 with a wall 104, a floor 105 and a ceiling 106, with the door 100 being assigned to the room 103.

The door closer 1 has a hydraulic damping mechanism 2 that dampens the opening and/or closing of the door 100. The damping mechanism 2 can ensure a gentle and controlled opening process of the door 100, for example to prevent damage to the door leaf 101. It is therefore conceivable that the door leaf 101 undergoes a comparatively fast opening movement, which is slowed down by the door closer 1. This prevents the door leaf 101 from impacting the wall 104 hard, for example. Alternatively or additionally, the damping mechanism 2 can ensure a gentle and controlled closing process of the door 100 in order to prevent any damage to the door leaf 101 and the door frame 102. In this case, for example, the door leaf 101 can undergo a comparatively fast closing movement, which is slowed down by the door closer 1 in order to prevent the door leaf 101 from impacting the door frame 102 hard.

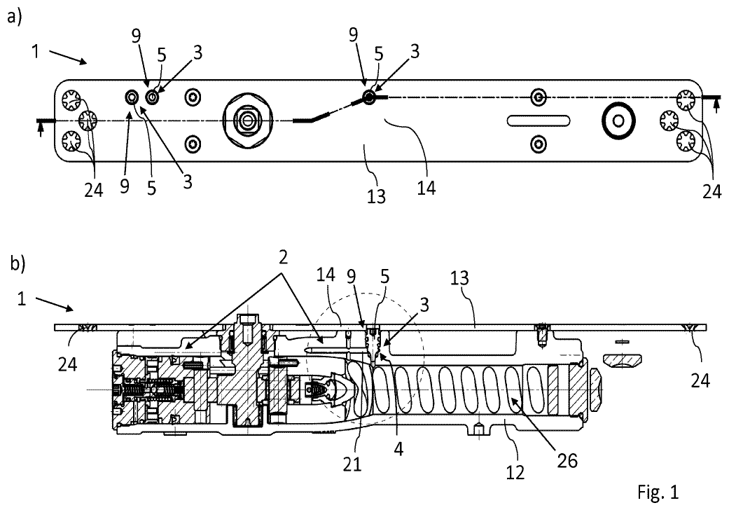

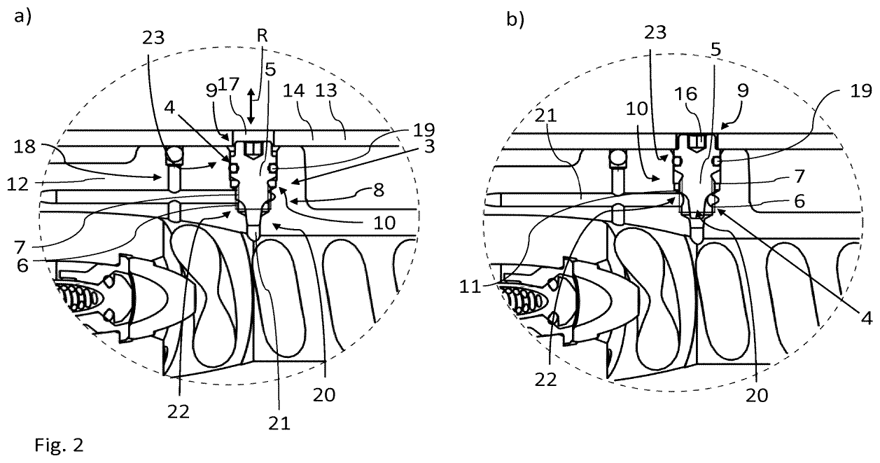

The opening movement and/or the closing movement can in principle be effected manually, i.e. by an operator, and/or automatically, i.e. by a door drive 26, for example. In the exemplary embodiment according to FIG. 1b), the door closer 1 has a mechanical door drive 26 with a spring mechanism. Here, and preferably, the closing movement of the door 100 can be effected by the door drive 26. The opening movement can at least be slowed down by the door drive 26. In principle, it is also possible to configure the door drive 26 electrically, for example with an electric drive motor mechanism, or electromechanically, for example with a spring mechanism and an electric drive motor mechanism. Configurations of this kind are known and are not described further here.

Irrespective of this, the damping mechanism 2 is in the form of a hydraulic damping mechanism 2. Accordingly, the damping mechanism 2 has a hydraulic fluid, such as oil or an oil mixture. The damping mechanism 2 can, as in this case, have one or a plurality of channels 21. The hydraulic fluid can flow through the channel(s) 21, for example as the door 100 is opened and/or closed. The damping caused by the damping mechanism 2 results from the fact that during the opening and/or closing of the door 100, the hydraulic fluid flows with flow resistance within certain inner components of the door closer 1, such as the channel or channels 21, such that a damping effect occurs.

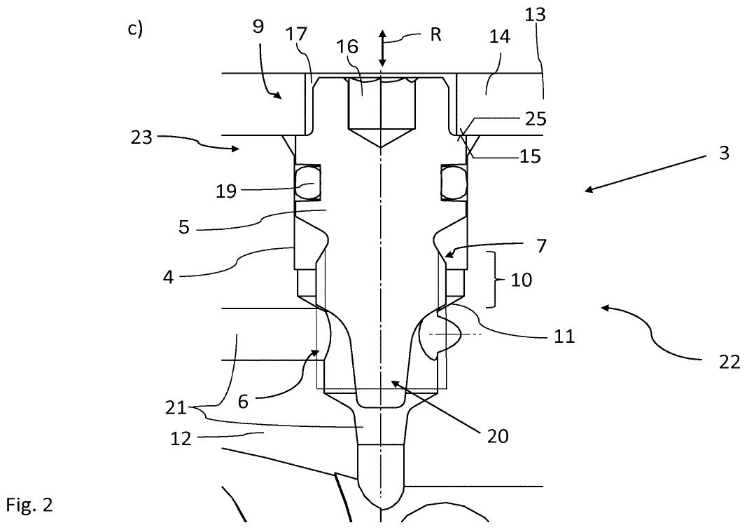

The damping mechanism 2 has at least one valve 3. The valve 3 is, here and preferably, in the form of a throttle valve. The damping properties of the damping mechanism 2 can be set via the valve 3, for example by increasing or reducing the flow resistance for the hydraulic fluid. This can be done manually by a fitter, for example, as part of the installation of the door closer 1. Here, and preferably, the channel 21 is assigned to the valve 3, the flow cross-section of which channel can be closed, reduced and enlarged locally by setting the valve 3. In FIG. 2a), the valve 3 is shown in a closed position, in which the flow channel 21 is closed. In FIGS. 2b) and 2c), the valve 3 is shown in an open position, in which hydraulic fluid can flow through the flow channel 21. Nevertheless, the valve 3 can be adjusted to any intermediate position. In the exemplary embodiment according to FIGS. 1a) and 1b), the damping mechanism 2 has a plurality of valves 3, in particular three valves 3. Each of the valves 3 can be used to set certain damping properties of the damping mechanism 2. Each of the valves 3 can be in the form a throttle valve.

The valve 3 has a valve guide 4 and a valve element 5. The valve element 5 is arranged within the valve guide 4. With regard to FIGS. 2a), 2b) and 2c), the valve element 5 is, here and preferably, arranged completely within the valve guide 4. The valve element 5 has a closing section 20 for closing and/or opening the channel 21. As discussed above, the closing section 20 can be used to close, reduce and enlarge the flow cross-section locally as required.

The valve guide 4 has a first threaded section 6. Here, and preferably, the first threaded section 6 is in the form of an inner threaded section. The channel 21 can protrude through the first threaded section 6. The valve element 5 has a second threaded section 7. Here, and preferably, the second threaded section 7 is in the form of an outer threaded section.

The first threaded section 6 of the valve guide 4 and the second threaded section 7 of the valve element 5 can be brought into engagement with each other in such manner that they form an adjusting threaded connection 8. The adjusting threaded connection 8 allows the valve element 5 to be adjusted within the valve guide 4 in the axial direction R by screwing. Within the meaning of this application, the “axial direction R” refers to the valve guide 4 and/or in particular to the valve element 5. The axial direction can in particular run along the longitudinal axis of the valve element 5 and/or the valve guide 4. The valve element 5 can be screwed in and out of the valve guide 4, for example when setting the damping mechanism 2. In general, the positional relationship between the valve element 5 and the valve guide 4 can be determined by adjusting the valve element 5 and thus, in particular, the flow resistance can be set, for example, increased or decreased. This can be seen from the combination of FIGS. 2a) and 2b), with adjustment to any intermediate positions (not represented) also being conceivable.

What is now essential for the proposed door closer 1 is that the valve guide 4 has a freewheel section 10 and that the valve element 5 can be adjusted within the valve guide 4 in the axial direction R in such manner that the first threaded section 6 and the second threaded section 7 are disengaged.

The freewheel section 10 allows the threaded sections 6 and 7, which are engaged with each other, to be separated from each other, i.e. can be brought out of engagement. This is achieved by adjusting the valve element 5 within the valve guide 4 in such manner that the second threaded section 7 is moved completely into the freewheel section 10. The valve element 5 can be adjusted in particular by a fitter. For the exemplary embodiment, this relationship results from the combination of FIG. 2a), in which the threaded sections 6, 7 are engaged with each other, and FIG. 2b), in which the threaded sections 6, 7 are disengaged. When the threaded sections 6, 7 are disengaged, the valve element 5 can be moved in a rotating manner stroke-free with respect to the valve guide 4 due to the freewheel section 10.

Here and preferably, the freewheel section 10 is arranged in the axial direction R next to the first threaded section 6. The first threaded section 6 ends, here and preferably, on one side towards the freewheel section 10. As in this case, the first threaded section 6 can have a smaller diameter compared to the freewheel section 10, at least in sections.

The door closer 1 preferably has a stop safety device 9, as in this case. The stop safety device 9 secures the valve element 5 within the valve guide 4 in the axial direction R. To a certain extent, the stop safety device 9 determines the movability of the valve element 5 within the valve guide 4. This is shown in FIGS. 2 b) and 2 c). The stop safety device 9 can be arranged in the axial direction R next to the valve element 5.

When the first threaded section 6 and the second threaded section 7 are disengaged, the valve element 5 can, here and preferably, be moved in the axial direction R into at least one end position. As soon as the valve element 5 is adjusted within the valve guide 4 in such manner that the threaded sections 6, 7 are disengaged, the valve element 5 can be moved further in the axial direction R with respect to the valve guide 4 until it reaches the end position. This can be pressure-induced, for example, due to the hydraulic pressure within the damping mechanism 2. In FIGS. 2b) and 2c), the valve element 5 is moved into the end position.

It is conceivable that, when the first threaded section 6 and the second threaded section 7 are disengaged, the valve element 5 can be adjusted, in particular substantially exclusively, linearly in the axial direction R with respect to the valve guide 4. With regard to FIG. 2c), it can be seen that as soon as the first threaded section 6 and the second threaded section 7 are disengaged, the valve element 5 can be moved in the axial direction R by a comparatively small distance of, for example, at most 5 mm, preferably at most 3 mm, further preferably at most 1 mm, when moving into the end position.

The stop safety device 9 can, as in this case, determine the end position of the valve element 5 and secure the valve element 5 in the end position. This makes it possible to restrict the movability of the valve element 5 with respect to the valve guide 4, even if the first threaded section 6 and the second threaded section 7 are disengaged.

In connection with the end position, it is possible that when the first threaded section 6 and the second threaded section 7 are disengaged, the valve element 5 can be moved, in particular proceeding from the end position, into a further end position in which the first threaded section 6 and the second threaded section 7 can be brought into engagement with each other. The valve element 5 can thus be moved back and forth between the end position and the further end position in the axial direction R. The valve element 5 can, for example, be moved proceeding from the end position into the further end position as part of the setting of the damping mechanism, for example by applying a compressive force via a tool. With regard to FIG. 2c), the further end position here corresponds to the position in which the valve element 5 is moved downwards in the figure, but the first threaded section 6 and the second threaded section 7 are not engaged with each other. Proceeding from the further end position, the valve element 5 can be moved by screwing such that the first threaded section 6 and the second threaded section 7 come into engagement.

In particular with regard to FIG. 2c), it can be seen that the freewheel section 10 preferably has a centring region 11 at the end for centring the valve element 5 within the valve guide 4. The centring region 11 can adjoin the first threaded section 6 in the axial direction R and/or in particular be conical in shape. The centring region 11 allows the valve element 5 to be centred at least in such manner that the first threaded section 6 and the second threaded section 7 can be brought into engagement, in particular when the valve element 5 is adjusted into the further end position.

Here and preferably, the door closer 1 has a housing 12. The housing 12 can receive inner components of the door closer 1, such as for example the damping mechanism 2 and the valve 3, and protect them from external environmental influences, such as moisture and dirt. The valve guide 4 can be arranged on and/or, as in this case, in the housing 12. The valve guide 4 is preferably arranged completely in the housing 12. The housing 12 and the arrangement of the valve guide 4 in the housing 12 can be seen, for example, in the sectional representation according to FIGS. 1b), 2a) to 2c).

In this context, it has proven to be particularly preferable if the valve guide 4 is designed in the manner of a guide bore with different diameters. The valve guide 4 can have a plurality of diameters, as in this case. The diameter of the freewheel section 10 is preferably larger than the diameter of the first threaded section 6, at least in sections and in particular at every point.

The door closer 1 also preferably has a cover 13. The cover 13 is arranged on the housing 12, in particular fixedly. As can be seen in FIGS. 1a) and 1b), for example, and preferably, the cover 13 is screwed to the housing 12. Alternatively or additionally, it is conceivable that the cover 13 is adhered, welded, clamped, screwed and/or clipped to the housing 12. The cover 13 covers the housing 12 at least partially, preferably completely. “Completely cover” in this context means that the cover 13 extends in at least two dimensions over the entire extent of the housing 12. With regard to FIGS. 1a) and 1b), this means, for example, that the width of the cover 13 exceeds the width of the housing 12 (in FIGS. 1a) and 1b) from left to right) and the depth of the cover 13 exceeds or corresponds to the depth of the housing 12 (in FIG. 1a) from bottom to top).

In connection with the cover 13, it can particularly advantageously be provided that the cover 13 has a, in particular substantially flat, plate section 14. It is conceivable that the cover 13 also has other components, such as curved sections which, for example, adjoin the plate section 14, elements which, for example, are arranged on the plate section 14 and/or, as in this case, one or a plurality of fastening recesses 24. It is also conceivable in principle that the cover 13 has a curved shell section as an alternative or in addition to the plate section 14.

With regard to the stop safety device 9, it is preferably provided that the stop safety device 9 is arranged on the cover 13, in particular in a non-rotatable manner. The stop safety device 9 can preferably be moulded onto the cover 13, in particular, as in this case, onto the plate section 14. The stop safety device 9 can be arranged in a non-rotatable manner with respect to the valve guide 4. In view of how the valve element 5 is adjusted, this has the advantage that the stop safety device 9 cannot be loosened unintentionally. Alternatively or additionally, it is possible that the stop safety device 9 is arranged in a non-rotatable manner with respect to the housing 12.

In the exemplary embodiment for example according to FIGS. 1a) and 1b), the stop safety device 9 is moulded onto the plate section 14 and arranged on the cover 13 in a non-rotatable manner. The cover 13 is fixedly connected to the housing 12, with the valve guide 4 being fixedly arranged on the housing 12. In the present case, this means that the stop safety device 9 is also non-rotatable with respect to the valve guide 4 and the housing 12.

Here, and particularly advantageously, the stop safety device 9 can be threadless. The stop safety device 9 can also be arranged at least partially or, as in this case, completely outside the valve guide 4.

With regard to the cover 13, it has proved useful if the cover 13 is configured in such manner that the housing 12 can be fastened via the cover 13, as indicated schematically in FIG. 3. For this purpose, as already mentioned above, the cover 13 can have one or a plurality of fastening recesses 24, through which one or a plurality of fastening means, such as for example screws, can be passed. The housing 12 can preferably be fastened via the cover 13 to the door 100, in particular to the door leaf 101 or the door frame 102, or to the wall 104, the floor 105 or the ceiling 106. The housing 12 is quite particularly preferably arranged in the door 100, i.e. in the door leaf 101 or the door frame 102, or in the wall 104, in the floor 105 or in the ceiling 106, via the cover 13. In FIG. 3, the housing 12 is arranged in the door 100, here in the door leaf 101, via the cover 13. The cover 13 closes, here and preferably, flush on one side with the door leaf 101.

It has already been described above that the stop safety device 9 secures the valve element 5. Although the configuration of the stop safety device 9 and thus also the securing can in principle be carried out in different ways, it is provided here and preferably that the stop safety device 9 secures the valve element 5 along a securing surface 15 in a form-fitting manner. At least when the valve element 5 is moved into the end position (FIGS. 2b) and 2c)), between the valve element 5 and the stop safety device 9 is formed a form-fit engagement, which prevents the valve element 5 from moving beyond the end position. The valve element 5 can have a counter surface 25. The securing surface 15 and the counter surface 25 can abut or come into contact with each other, in particular when the valve element 5 is moved into the end position. In connection with the securing surface 15, it is possible that the securing surface 15 is circumferential. Here and preferably, the securing surface 15 is ring-shaped.

It has already been discussed above in another context that the valve element 5 can be adjusted within the valve guide 4 in the axial direction R by means of a tool, such as for example a screwing tool. Against this background, it is of great advantage if the valve element 5 has a tool receptacle 16 for temporarily receiving a tool or the tool, as is implemented in the exemplary embodiment according to FIGS. 2a), 2b) and 2c), for example. Here and preferably, the tool receptacle 16 is arranged at the end of the valve element 5. The tool receptacle 16 is arranged opposite the closing section 20 in particular. In order to adjust the valve element 5 even when the cover 13 is mounted, it is provided here and preferably that the stop safety device 9 has a recess 17 through which the tool can be passed at least partially through the stop safety device 9 to the tool receptacle 16. In this case, the stop safety device 9 is arranged opposite the valve element 5 in the axial direction R. The tool receptacle 16 can, as in this case, face the cover 13.

It has already been discussed above that the damping mechanism 2 has the hydraulic fluid. In order to prevent any loss of hydraulic fluid and also to protect the damping mechanism 2 from air, dirt and/or moisture, it is therefore particularly advantageous if the door closer 1 has a sealing arrangement 18 for sealing the hydraulic damping mechanism 2 with at least one sealing element 19. The sealing arrangement 18 seals the damping mechanism 2 from the environment, i.e. in particular from the outside of the housing 12.

As can be seen in FIG. 2c), the sealing element 19 is arranged between the valve guide 4 and the valve element 5. The sealing element 19 thus seals the valve 3. Here and preferably, the sealing element 19 is arranged between the valve guide 4 and the valve element 5 in a radially sealing manner. Here and preferably, the sealing element 19 is in the form of an elastic sealing element 19, in particular an O-ring. The valve guide 4 and/or the valve element 5 can each have a cylindrical sealing surface against which the sealing element 19 rests.

In principle, it is possible that the sealing element 19 is arranged on the valve guide 4 and the valve element 5 can be moved in the axial direction R with respect to the sealing element 19 and the valve guide 4. In this case, the sealing element 19 remains stationary in relation to the other components of the door closer 1 as the valve element 5 is adjusted. Here and preferably, however, it is provided that the sealing element 19 is arranged on the valve element 5 and can be moved with the valve element 5 in the axial direction R. In this case, the sealing element 19 is moved in relation to the other components of the door closer 1 as the valve element 5 is adjusted. This can be seen from FIGS. 2a) and 2b).

FIGS. 2a), 2b) and 2c) show that the valve guide 4 has a fluid region 22 and a dry region 23, with the sealing element 19 spatially separating the fluid region 22 and the dry region 23 from each other. The fluid region 22 is the region of the valve guide 4 that has hydraulic fluid. The dry region 23 is the region of the valve guide 4 that is free of hydraulic fluid. The freewheel section 10 of the valve guide 4 can be arranged, as in this case, in particular completely, in the fluid region 22 (FIG. 2c)). The first threaded section 6 and/or the second threaded section 7 can be arranged in the fluid region 22. Alternatively or additionally, the dry region 23 is, here and preferably, threadless.

1. A door closer for opening and/or closing a door, wherein the door closer has a hydraulic damping mechanism for damping the opening and/or closing of the door with at least one valve for setting the damping properties of the damping mechanism, wherein the valve has a valve guide and a valve element arranged within the valve guide, wherein the valve guide has a first threaded section and the valve element has a second threaded section, which can be brought into engagement with each other such that they form an adjusting threaded connection for adjusting the valve element within the valve guide in the axial direction, wherein the door closer in particular has a stop safety device for securing the valve element within the valve guide in the axial direction,
wherein the valve guide has a freewheel section and the valve element can be adjusted within the valve guide in the axial direction such that the first threaded section and the second threaded section are disengaged.

2. The door closer according to claim 1, wherein the valve element, which is adjusted such that the first threaded section and the second threaded section are disengaged, can be moved in the axial direction into at least one end position, wherein the stop safety device fixes the end position of the valve element and secures the valve element in the end position, preferably in that the valve element, which is adjusted such that the first threaded section and the second threaded section fare disengaged, can be moved into a further end position in which the first threaded section and the second threaded section can be brought into engagement.

3. The door closer according to claim 1, wherein the freewheel section has a, in particular conical, centering region at the end for centering the valve element within the valve guide.

4. The door closer according to claim 1, wherein the door closer has a housing and in that the valve guide is arranged on and/or in the housing, preferably in that the valve guide is designed in the manner of a guide bore with different diameters.

5. The door closer according to claim 4, wherein the door closer has a cover which is arranged on the housing and at least partially covers the housing, preferably in that the cover has a, in particular substantially flat, plate section.

6. The door closer according to claim 5, wherein the stop safety device is arranged on the cover, in particular in a non-rotatable manner, preferably in that the stop safety device is moulded onto the cover.

7. The door closer according to claim 5, wherein the cover is configured such that the housing can be fastened via the cover, in particular on or in the door or on or in a wall, a floor or a ceiling of a room to which the door is assigned.

8. The door closer according to claim 1, wherein the stop safety device is arranged in a non-rotatable manner with respect to the valve guide and/or the housing.

9. The door closer according to claim 1, wherein the stop safety device is threadless.

10. The door closer according to claim 1, wherein the stop safety device secures the valve element along a, in particular circumferential, preferably ring-shaped, securing surface in a form-fitting manner.

11. The door closer according to claim 1, wherein the valve element has a tool receptacle, in particular at the end, for temporarily receiving a tool, preferably in that the stop safety device is arranged opposite the valve element in the axial direction and has a recess for at least partially passing the tool through the stop safety device towards the tool receptacle.

12. The door closer according to claim 1, wherein the door closer has a sealing arrangement for sealing the hydraulic damping mechanism, in particular with respect to the exterior of the housing, with at least one sealing element, and in that the sealing element is arranged in a sealing manner, in particular in a radially sealing manner, between the valve guide and the valve element, preferably in that the sealing element is arranged on the valve element and can be moved with the valve element in the axial direction, or in that the sealing element is arranged on the valve guide and the valve element can be moved in the axial direction with respect to the sealing element and the valve guide.

13. The door closer according to claim 12, wherein the valve guide has a fluid region, in particular having hydraulic fluid, and a dry region, in particular free of hydraulic fluid, wherein the sealing element spatially separates the fluid region and the dry region from each other, preferably in that the first threaded section and/or the second threaded section is/are arranged in the fluid region, and/or in that the dry region is threadless.

14. The door closer according to claim 1, the valve element has a closing section, in particular opposite the tool receptacle, for closing and/or opening at least one channel of the damping mechanism.

15. A system with a door, which has a door leaf, and with a door closer, wherein the door closer is designed according to claim 1.
